(19) United States
(12) Patent Application Publication
(10) Pub. No.: US 2024/0106648 A1
(43) Pub. Date: Mar. 28, 2024

(54) GRAPHICAL VISUALIZATION OF TRUST RELATIONSHIPS BETWEEN ACCOUNTS AND SSH PROTOCOL KEYS FOR NETWORK ATTACK PATH DETECTION

(71) Applicant: Citrix Systems, Inc., Ft. Lauderdale, FL (US)

(72) Inventors: Paul Beesley, Cambridge (GB); Andrew David Cooper, Cambridge (GB); Robert William Dalgleish, Cambridge (GB)

(21) Appl. No.: 17/935,271

(22) Filed: Sep. 26, 2022

(51) Int. Cl. H04L 9/30; G06F 16/901; H04L 9/08; H04L 9/14

(52) U.S. Cl. CPC H04L 9/3073; G06F 16/9024; H04L 9/0863; H04L 9/14

(57) ABSTRACT

A computer system is provided. The computer system includes a memory and at least one processor coupled to the memory and configured to deploy public key enumeration code and private key enumeration code to a plurality of endpoint devices for execution on the endpoint devices. The at least one processor is further configured to collect public keys and associated public key metadata from the endpoint devices, and to collect private key metadata from the endpoint devices. The public keys and associated public key metadata are generated by the public key enumeration code and the private key metadata is generated by the private key enumeration code. The at least one processor is further configured to generate a graph illustrating trust relationships between user accounts on the endpoint devices. The graph is based on the collected public keys, the collected public key metadata, and the collected private key metadata.

### BACKGROUND

Connections between computer systems are often made using the Secure Shell (SSH) protocol which relies on public/private key authentication to grant access to user accounts on the connected machines. This process can lead to a number of security issues that result from poor management of the public/private key pairs. Compromised keys can allow malicious actors to exploit trusted relationships between user accounts and machines turning these into attack paths that can extend throughout a network or organization.

### SUMMARY

In at least one example, a computer system is provided. The computer system includes a memory; and at least one processor coupled to the memory and configured to: deploy public key enumeration code to a plurality of endpoint devices for execution on the endpoint devices; deploy private key enumeration code to the plurality of endpoint devices for execution on the endpoint devices; collect public keys and associated public key metadata from the endpoint devices, the public keys and associated public key metadata generated by the public key enumeration code; collect private key metadata from the endpoint devices, the private key metadata generated by the private key enumeration code; and generate a graph illustrating trust relationships between user accounts on the endpoint devices, the graph based on the collected public keys, the collected public key metadata, and the collected private key metadata.

At least some examples of the computer system can include one or more of the following features. The public key enumeration code is configured to: identify user accounts on the endpoint device; locate public keys associated with each of the user accounts; and calculate a fingerprint of each of the located public keys for inclusion in the associated public key metadata. The private key enumeration code is configured to: identify user accounts on the endpoint device; locate private keys associated with each of the user accounts; calculate a fingerprint of each of the located private keys for inclusion in the associated private key metadata; and determine password protection status of the located private keys for inclusion in the associated private key metadata. The graph comprises a plurality of nodes, each of the nodes representing one of a user account, a machine, a sub-network, or a pairing of public key and private key. The graph comprises a plurality of edges, each of the edges connecting two or more of the nodes, each of the edges representing one or more of an authorization relationship between the two or more nodes, an ownership relationship between the two or more nodes, or a presence relationship between the two or more nodes. The at least one processor is further configured to: store the plurality of nodes and the plurality of edges in a graph database; and provide access to the graph database using a graph query language. The at least one processor is further configured to: provide a user interface to enable entry of a request using the graph query language; and display a requested graph, the requested graph comprising a subset of the plurality of nodes and a subset of the plurality of edges, the subset of the plurality of nodes and the subset of the plurality of edges specified by the request.

In at least one example, a method for graphical visualization of trust relationships is provided. The method includes: deploying, by a computer system, public key enumeration code to a plurality of endpoint devices for execution on the endpoint devices; deploying, by the computer system, private key enumeration code to the plurality of endpoint devices for execution on the endpoint devices; collecting, by the computer system, public keys and associated public key metadata from the endpoint devices, the public keys and associated public key metadata generated by the public key enumeration code; collecting, by the computer system, private key metadata from the endpoint devices, the private key metadata generated by the private key enumeration code; and generating, by the computer system, a graph illustrating trust relationships between user accounts on the endpoint devices, the graph based on the collected public keys, the collected public key metadata, and the collected private key metadata.

At least some examples of the method can include one or more of the following features. The public key enumeration code is configured to: identify user accounts on the endpoint device; locate public keys associated with each of the user accounts; and calculate a fingerprint of each of the located public keys for inclusion in the associated public key metadata. The private key enumeration code is configured to: identify user accounts on the endpoint device; locate private keys associated with each of the user accounts; calculate a fingerprint of each of the located private keys for inclusion in the associated private key metadata; and determine password protection status of the located private keys for inclusion in the associated private key metadata. The graph comprises a plurality of nodes, each of the nodes representing one of a user account, a machine, a sub-network, or a pairing of public key and private key. The graph comprises a plurality of edges, each of the edges connecting two or more of the nodes, each of the edges representing one or more of an authorization relationship between the two or more nodes, an ownership relationship between the two or more nodes, or a presence relationship between the two or more nodes. The method further includes: storing the plurality of nodes and the plurality of edges in a graph database; and providing access to the graph database using a graph query language. The method further includes: providing a user interface to enable entry of a request using the graph query language; and displaying a requested graph, the requested graph comprising a subset of the plurality of nodes and a subset of the plurality of edges, the subset of the plurality of nodes and the subset of the plurality of edges specified by the request.

In at least one example a non-transitory computer readable medium storing executable sequences of instructions to provide graphical visualization of trust relationships, the sequences of instructions comprising instructions to: deploy public key enumeration code to a plurality of endpoint devices for execution on the endpoint devices; deploy private key enumeration code to the plurality of endpoint devices for execution on the endpoint devices; collect public keys and associated public key metadata from the endpoint devices, the public keys and associated public key metadata generated by the public key enumeration code; collect private key metadata from the endpoint devices, the private key metadata generated by the private key enumeration code; and generate a graph illustrating trust relationships between user accounts on the endpoint devices, the graph based on the collected public keys, the collected public key metadata, and the collected private key metadata.

At least some examples of the non-transitory computer readable medium can include one or more of the following features. The public key enumeration code is configured to: identify user accounts on the endpoint device; locate public keys associated with each of the user accounts; and calculate a fingerprint of each of the located public keys for inclusion in the associated public key metadata. The private key enumeration code is configured to: identify user accounts on the endpoint device; locate private keys associated with each of the user accounts; calculate a fingerprint of each of the located private keys for inclusion in the associated private key metadata; and determine password protection status of the located private keys for inclusion in the associated private key metadata. The graph comprises a plurality of nodes, each of the nodes representing one of a user account, a machine, a sub-network, or a pairing of public key and private key. The graph comprises a plurality of edges, each of the edges connecting two or more of the nodes, each of the edges representing one or more of an authorization relationship between the two or more nodes, an ownership relationship between the two or more nodes, or a presence relationship between the two or more nodes. The sequences of instructions further include instructions to: store the plurality of nodes and the plurality of edges in a graph database; provide access to the graph database using a graph query language; provide a user interface to enable entry of a request using the graph query language; and display a requested graph, the requested graph comprising a subset of the plurality of nodes and a subset of the plurality of edges, the subset of the plurality of nodes and the subset of the plurality of edges specified by the request.

Still other aspects, examples and advantages of these aspects and examples, are discussed in detail below. Moreover, it is to be understood that both the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 illustrates attack paths between user accounts on different machines, in accordance with an example of the present disclosure.

FIG. 2 is a block diagram of a trust mapping system, in accordance with an example of the present disclosure.

FIG. 3 illustrates a trust relationship graph, in accordance with an example of the present disclosure.

FIG. 4 illustrates a user interface for the trust mapping system, in accordance with an example of the present disclosure.

FIG. 5 is a flow diagram of a process for public key enumeration, in accordance with an example of the present disclosure.

FIG. 6 is a flow diagram of a process for private key enumeration, in accordance with an example of the present disclosure.

FIG. 7 is a flow diagram of a process for data aggregation and transformation, in accordance with an example of the present disclosure.

FIG. 8 is a flow diagram of a process for providing graphical visualization of trust relationships, in accordance with an example of the present disclosure.

FIG. 9 is a block diagram of a computing platform configured to perform a process for providing graphical visualization of trust relationships, in accordance with an example of the present disclosure.

### DETAILED DESCRIPTION

As noted previously, connections between computer systems are often made using an SSH protocol that employs public/private key pairs. This protocol uses public key authentication, in which a private key possessed by a user grants access to user accounts (on the same machine or different machines) where the associated public key has been marked as authorized. This process can raise security issues that result from poor management of the public/private key pairs. For example, private keys may be leaked, shared, failed to be stored under password protection, or fail to be revoked when a user leaves the organization. Compromised keys can then allow malicious actors to exploit trusted relationships between user accounts and machines and use these relationships as attack paths that can extend throughout a network or organization. For example, a single compromised private key may be used as a staring point to exploit a trust relationship to compromise other user accounts which, in turn, may possess additional private keys that grant access to yet more accounts, and so on. Often, these attack paths are only detected after a security incident occurs and the path tracing process is largely manual and time-consuming.

To address these problems, and as summarized above, various examples described herein are directed to systems and methods for network attack path detection through the use of graphical visualization of trust relationships between accounts and SSH protocol keys (e.g., public private key pairs). In some examples, the systems and methods generate a graphical visualization of trust relationships by deploying public key enumeration code and private key enumeration code to a plurality of endpoint devices for execution on those endpoint devices. In some examples, the public key enumeration code and private key enumeration code is deployed to the endpoint devices from an endpoint management system. The public key enumeration code is configured to generate and provide public keys and associated public key metadata for collection by the endpoint management system. The private key enumeration code is configured to generate and provide private key metadata for collection by the endpoint management system. A graph illustrating trust relationships between user accounts on the endpoint devices can then be generated based on an aggregation of the collected public keys, the collected public key metadata, and the collected private key metadata.

In some examples, the trust relationship graph includes nodes connected by edges. The nodes may represent a user account, a machine, a network or sub-network, or a pairing of public key and private key (e.g., a key pair). The edges may represent some form of authorization or privilege that exists between the connected nodes which indicates a trust relationship. The edges may also represent a presence relationship between the connected nodes (e.g., a user account on node 1 is present on a machine represented by node 2, or a machine represented by node 2 is present on a subnetwork represented by node 3).

In some examples, the nodes and edges of the graph are stored in a graph database which is configured for access using a graph query language. A user interface is provided to enable entry (for example by a system administrator) of graph display requests using the graph query language. The requests may call for display of a subset of the nodes and edges stored in the graph database, the subset comprising nodes and edges of interest to the administrator.

As will be understood in view of this disclosure, the systems and methods for graphical visualization of trust relationships for network attack path detection provided herein have several advantages over existing methods which typically require manual tracing of vulnerable paths after the occurrence of a security breach. Additionally, the disclosed systems and methods do not require continuous monitoring of network traffic between machines and thus avoid the performance impact of traffic interception and data storage.

Examples of the methods and systems discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

### Trust Mapping System

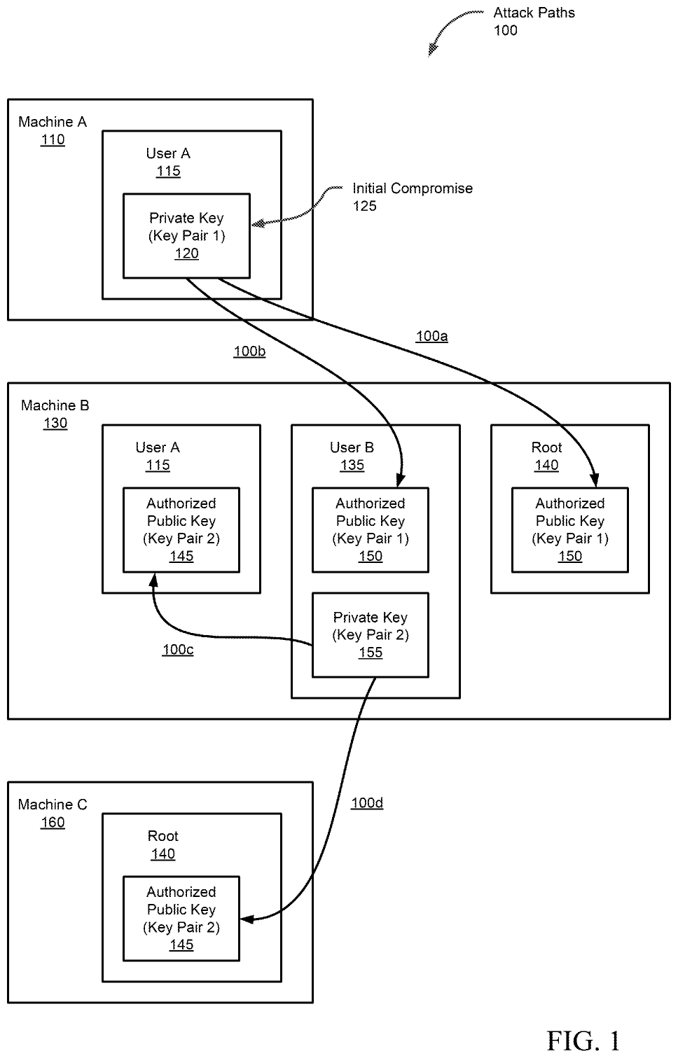

FIG. 1 illustrates attack paths 100 between user accounts on different machines, in accordance with an example of the present disclosure. For example, user A 115 on machine A 110 may employ a private key 120, as part of a first private/public key pairing. The private key 120 can be used as part of an SSH protocol for gaining access and connecting to other accounts and other machines. If private key 120 is compromised (e.g., stolen, shared, leaked, or otherwise unprotected) it can be used to create initial direct attack paths 100a and/or 100b. For example, private key 120 can be used in attack path 100a to gain access to a root account 140 on machine B 130, through the trust relationship established by the authorized public key 150 of the first private/public key pairing. Root accounts generally have the highest privileges on a computer system, and so this attack path 100a can potentially open the door to more serious security breaches on machine B. This attack path provides the attacker with privilege escalation.

As a further example, private key 120 can be used in attack path 100b to gain access to the account of user B 135, on machine B 130, through the trust relationship established by the authorized public key 150 of the first private/public key pairing. From there, the attacker gains access to a private key 155 (of a second key pairing), owned by user B on machine B. The granted access is based on a trust relationship between the keys owned by user B. Continuing in a similar fashion, the attack can proceed through indirect (e.g., multi-hop) attack paths 100c and 100d. In attack path 100c, the attacker uses private key 155 to gain access to the account of user A on machine B through the trust relationship established by the authorized public key 145 of the second private/public key pairing. Similarly, in attack path 100d, the attacker uses private key 155 to gain access to the root account 140 on machine C 160 through the trust relationship established by the authorized public key 145 of the second private/public key pairing.

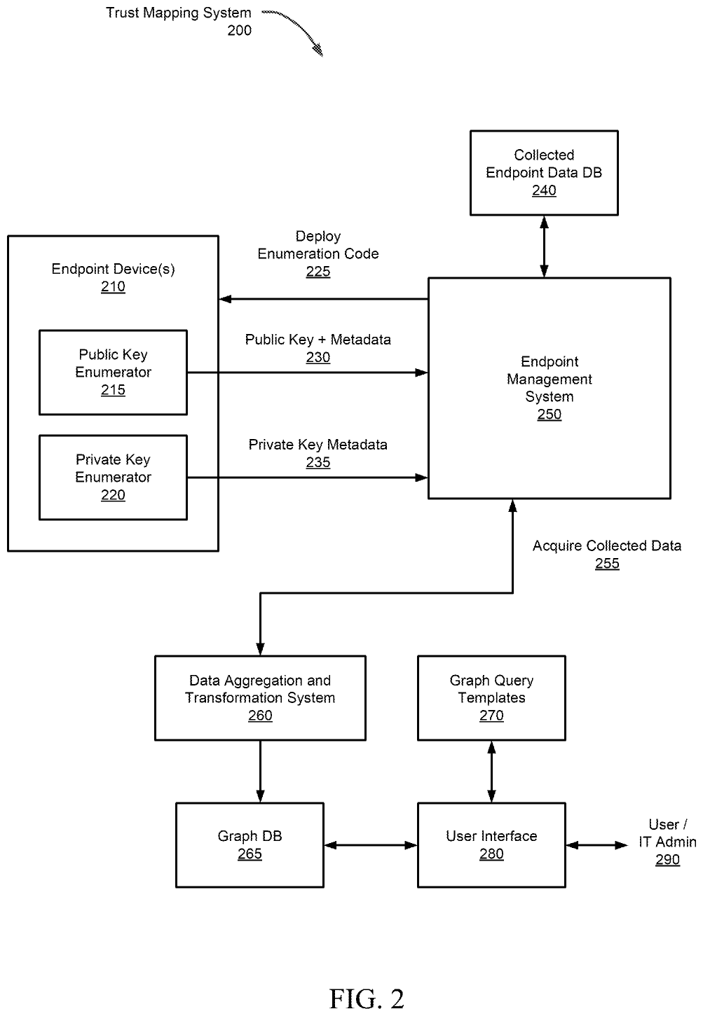

FIG. 2 is a block diagram of a trust mapping system 200, in accordance with an example of the present disclosure. As shown in FIG. 2, the trust mapping system includes an endpoint management system 250, a data aggregation and transformation system 260, a collected endpoint data database 240, a graph database 265, graph query templates 270, and a user interface 280. Also shown are endpoint devices 210, which may include user workstations, laptops, tablets, smartphones, etc.

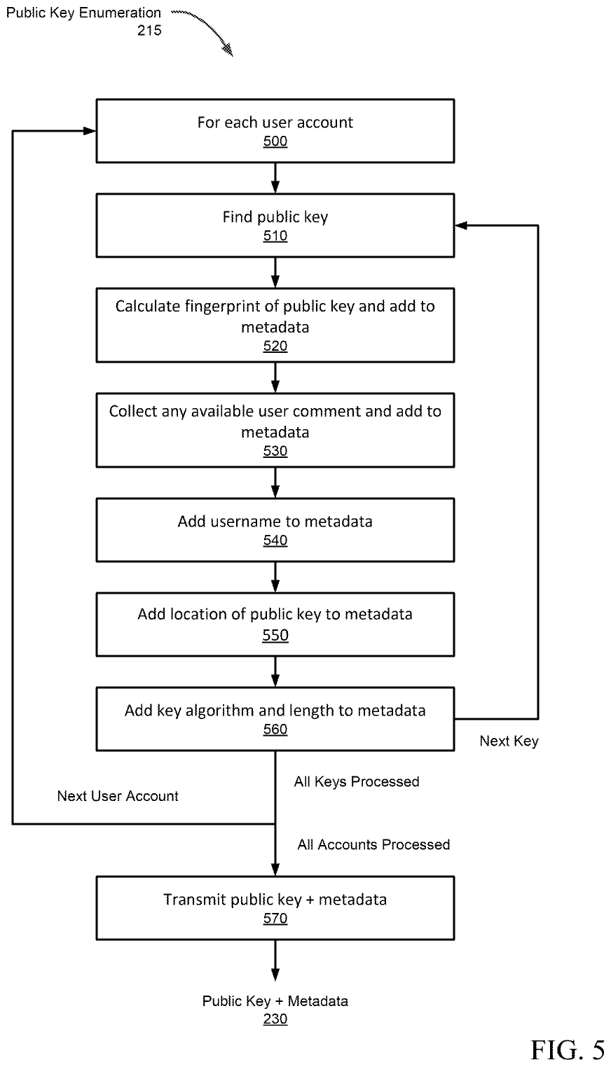

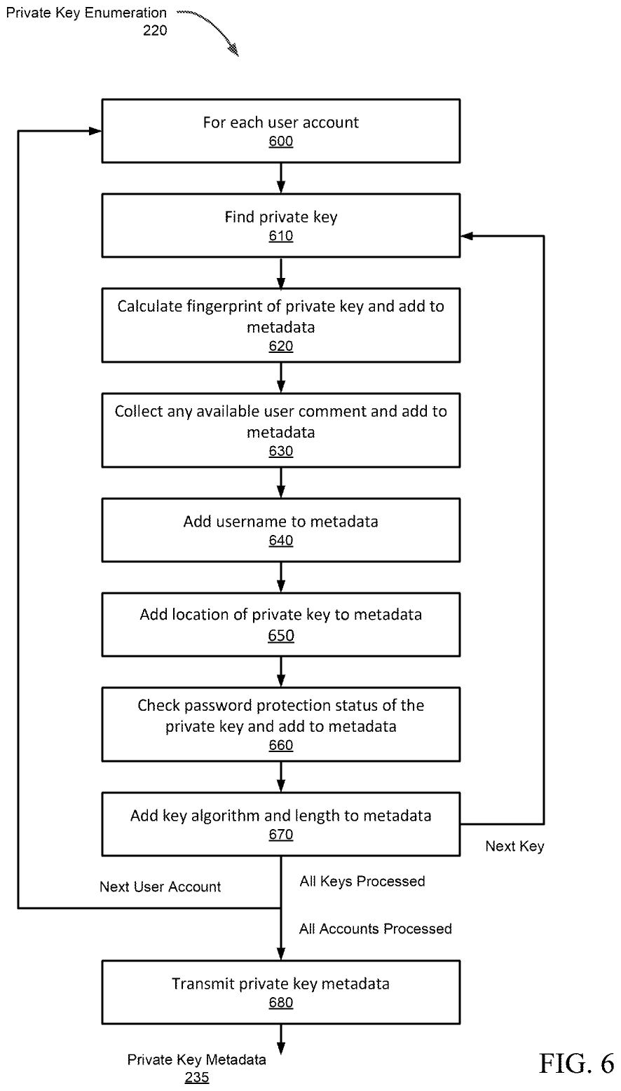

The endpoint management system 250 is configured to deploy 225 public key enumeration code 215 and private key enumeration code 220 to the endpoint devices for execution on those devices. The operation of the enumeration code will be described in greater detail below in connection with FIGS. 5 and 6. The endpoint management system 250 is further configured to collect the enumeration results (e.g., public keys and metadata 230 and private key metadata 235) generated by the execution of the enumeration code on the endpoint devices and store the collected data in database 240.

In some examples, the data aggregation and transformation system 260 may be configured to periodically initiate a refresh of the data collected from the endpoint devices 210, for example based on a device refresh schedule. In some examples, the schedule may initiate refreshes on a daily or weekly basis.

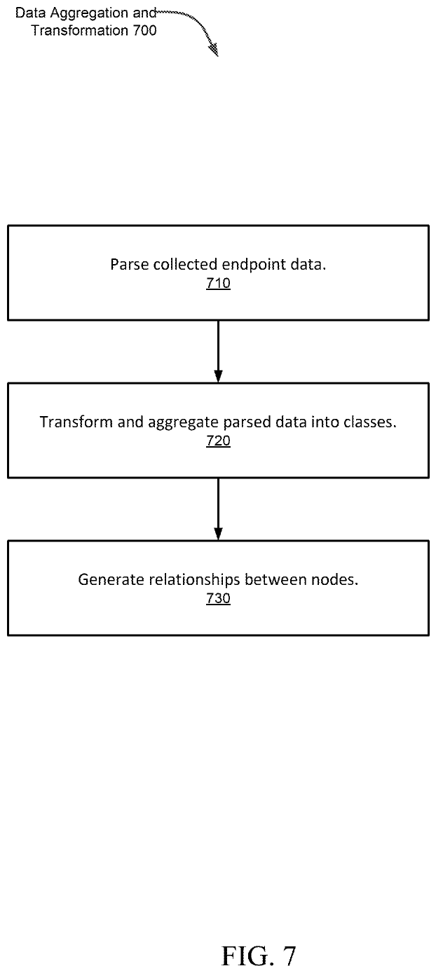

The data aggregation and transformation system 260 is configured to process the collected data, stored in database 240, to generate a trust relationship graph to be stored in graph database 265. The operation of data aggregation and transformation system 260 will be described in greater detail below in connection with FIG. 7, but at a high level it is configured to parse the data/metadata collected from the endpoint devices and convert the representation of that data into classes that represent the properties of a user account, a machine, or other object that can be represented by a node. The data aggregation and transformation system 260 is further configured to generate relationships between the nodes. The relationships may be based, for example, on pairings of user accounts with machines and on pairings of public key authorizations with user accounts and machines. The nodes and relationships (e.g., edges) are then stored in the graph database 265.

In some examples, the data aggregation and transformation system 260 may be configured to periodically initiate a refresh of the graph database 265, for example based on a graph refresh schedule.

The user interface 280 is configured to provide an interface (e.g., a graphical user interface) for a user, such as an IT administrator or security administrator, to interact and control the trust mapping system by querying the graph database 265 as described below. In some examples, graph query templates 270 are provided to assist with the graph query process. These templates may be written to expose certain types of attack paths within the graph and allow end users to replace any placeholder values (a machine name, IP address, username, etc.) with real data to constrain the graph search as required.

In some examples, the trust mapping system can be configured to run selected graph queries automatically (e.g., on a schedule or on a data refresh) to provide alerts if new attack paths and/or trust relationships are discovered.

In some examples, additional data can be collected from endpoint devices to expose poor security practices that involve machine-to-machine or account-to-account interactions. For example, network address data can be used to reveal SSH activity between a general corporate network and restricted sub-networks or off-site networks.

In some examples, the system can be used to identify insecure configurations of SSH host key pairs. For example, when connecting to a machine over SSH, the server-side presents the public portion of the host key pair and the client can use this as a means of verifying the identity of the server. It is possible to deploy multiple servers that share the same host key pair, either deliberately or accidentally (e.g., as a result of cloning a virtual machine (VM) or re-using a single VM image). This presents a security risk, as servers that share a host key pair can masquerade as each other.

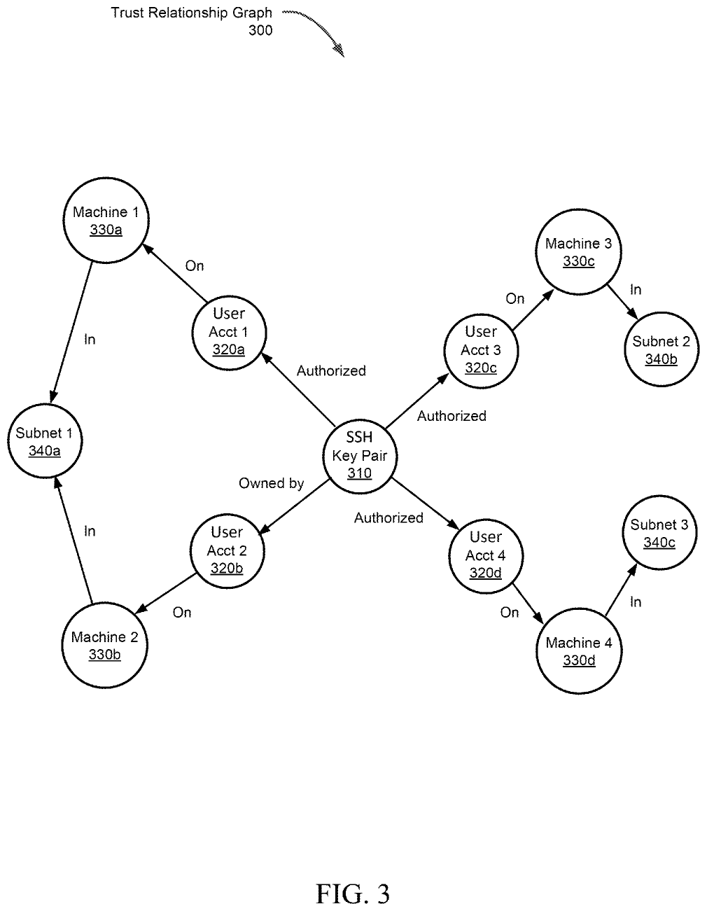

FIG. 3 illustrates a trust relationship graph 300, in accordance with an example of the present disclosure. In this example, a central node 310 represents an SSH key pair of interest to the administrator that requested the graph. Edges emanating from node 310 to nodes 320a, 320c, and 320d indicate that the private key of key pair 310 is associated with a public key of that key pair that provides authorization (e.g., access) to user accounts for users 1, 3 and 4. The edge emanating from node 310 to node 320b indicates that the user account (e.g., for user 2) owns the private key of that key pair and can therefore access the other user accounts for which node 310 has an authorized relationship. As such, if the private key were compromised, the other accounts would be endangered.

Continuing along the graph, the edge from node 320a to node 330a indicates that user account 1 is located on machine 1, and the edge from node 330a to node 340a indicates that machine 1 is in sub-network 1 340a. Similarly, the edge from node 320b to node 330b indicates that user account 2 is located on machine 2, and the edge from node 330b to node 340a indicates that machine 2 is also in sub-network 1 340a. Likewise, trust relationships are illustrated for user account 3 320c located on machine 3 330c in sub-network 2 340b, and user account 4 320d located on machine 4 330d in sub-network 3 340c.

It will be appreciated that this graph is simplified for clarity of explanation. In practice a requested graph may include hundreds of nodes and edges, or more, and may include nodes that represent additional properties of interest (e.g., password protection status of the private key, user comments associated with a key pairing, an indication of the key algorithm, etc.).

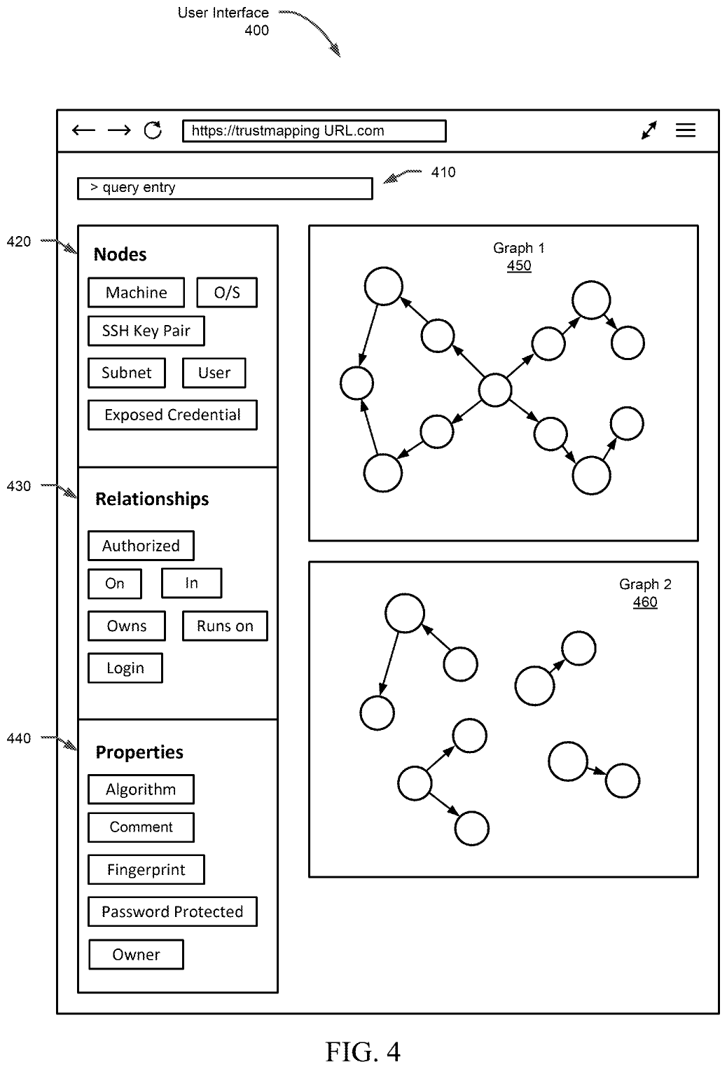

FIG. 4 illustrates a user interface 400 for the trust mapping system 200, of FIG. 2, in accordance with an example of the present disclosure. The user interface may include a query entry field 410 into which the user/administrator enters a query in the graph query language to request a graph that includes nodes, edges, and properties of interest.

One example of a query to display machines, users, and key pairs is:

# Show machines, users, and key pairs where a user on a machine has authorized a key pair
MATCH (user:User)-[r_associated:AUTHORIZED]-(key_pair:SSHKeyPair)
MATCH (user)-[r_on:ON]->(machine:Machine)

Another example of a query to expose privilege escalation is:

# Show paths involving privilege escalation from non-root to root accounts
# For all combinations of key pairs and user accounts:
# 1) Find non-root user accounts that own the private portion of the key pair
# 2) Find root accounts that authorize the public portion of the same key pair
# 3) Show the associated machines that user accounts are located on
# 4) Show the associated subnets that machines are located in
MATCH (user1:User)-[r_owns]->(key_pair:SSHKeyPair)
WHERE user1.name <> ′root′
MATCH (user2:User)<-[r_authorized:AUTHORIZED]-(key_pair)
WHERE user2.name = ′root′
UNWIND [user1,user2] AS user
MATCH (user)-[r_on:ON]-(machine:Machine)
MATCH (machine)-[r_in:IN]->(subnet:Subnet)

In some examples, nodes of interest may be specified using labeled buttons, as shown in the node panel 420. Some types of node specifications may include machine, O/S, a particular SSH key pair, a subnet, a user, or an exposed credential.

In some examples, relationships of interest may be specified using labeled buttons, as shown in the relationships panel 430. Some types of relationship specifications may include authorized, on, in, owns, runs on, and login.

In some examples, properties of interest may be specified using labeled buttons, as shown in the properties panel 440. Some types of property specifications may include key algorithm, user comments, fingerprint, password protection status, and owner.

Graphs that result from the query may be displayed, for example, as graph 1 450 and graph 2 460. Although two graphs are illustrated in FIG. 4, any number of graphs may be displayed. In some examples, the user interface 400 may be provided as a web page served by a web browser.

### Trust Mapping Process

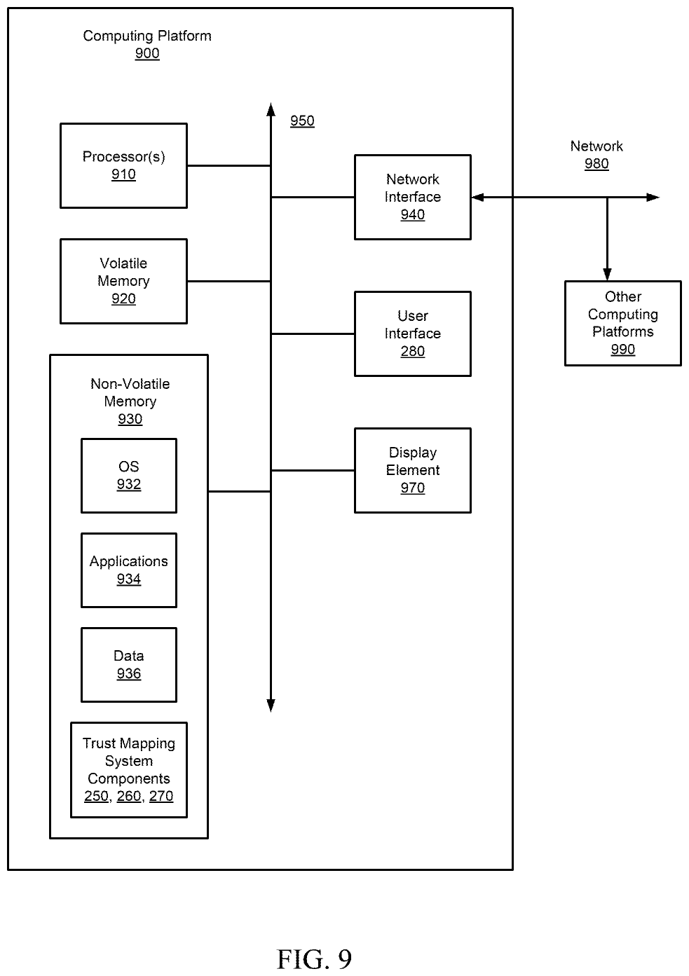

As described above, some examples of the system 200 of FIG. 2 are configured to perform a process for providing graphical visualization of trust relationships for attack path detection. The processes may be executed on a processor of any suitable type (e.g., processor 910 of FIG. 9).

FIG. 5 is a flow diagram of a process for public key enumeration 215, executed by an endpoint device 210, of FIG. 2, in accordance with an example of the present disclosure in accordance with an example of the present disclosure.

The process 215 starts at operation 500, by examining each user account on the endpoint device. In some examples, user accounts and home directories can be enumerated by parsing the “/etc/passwd” file.

At operation 510, a public key is found for that user. In some examples, public keys for the user may be found in the “./ssh/authorized_keys” file.

Next, at operation 520, a fingerprint (e.g., a hash) of the public key is calculated and added to a package of metadata. The fingerprint may be calculated using any suitable hashing algorithm including, for example, MD5 or SHA-256. In some examples, the fingerprint may be generated through the use of an O/S utility, for example by running “ssh-keygen-L”.

At operation 530, any available user comments associated with the public key are also added to the metadata package. The comments can be any free form text and are included so that they may later be inspected by a security administrator when viewing the trust relationship graph.

At operation 540, the username, that is associated with the public key, is added to the metadata package.

At operation 550, the location at which the public key was found (e.g., the directory path) is added to the metadata package.

At operation 560, the public key algorithm and the key length are added to the metadata package.

The process then loops back to operation 510 to find a next public key for that user account. When all public keys for that account have been found, the process loops back to operation 500 to examine the next user account on the endpoint device. When all accounts have been processed, the public keys and associated metadata package are transmitted back to the endpoint management system, at operation 570.

FIG. 6 is a flow diagram of a process for private key enumeration 220, executed by an endpoint device 210, of FIG. 2, in accordance with an example of the present disclosure.

The process 220 starts at operation 600, by examining each user account on the endpoint device. In some examples, user accounts and home directories can be enumerated by parsing the “/etc/passwd” file.

At operation 610, a private key is found for that user. In some examples, private keys are found by searching through a list of directories that are likely to store private keys. In some examples, the list may depend on details of the O/S configuration and/or may be provided by the security administrator. Files within those directories may be checked to determine if they contain private keys based on having a valid/expected size, encoding, preamble bytes, and/or other suitable characteristics.

Next, at operation 620, a fingerprint (e.g., a hash) of the found private key is calculated and added to a package of metadata. The fingerprint may be calculated using any suitable hashing algorithm. In some examples, the fingerprint may be generated through the use of an O/S utility, for example by running “ssh-keygen-L”. Only the fingerprint of the private keys are sent back (e.g., as part of the metadata package) to the endpoint management system, to preserve the confidentiality of the private keys.

At operation 630, any available user comments associated with the private key are also added to the metadata package.

At operation 640, the username, that is associated with the private key, is added to the metadata package.

At operation 650, the location at which the private key was found (e.g., the directory path) is added to the metadata package.

At operation 660, the password protection status of the private key is determined, and that status is added to the metadata package. In some examples, password protection status may be checked through the use of an O/S utility, for example by running “ssh-keygen-y-P <invalid_passphrase>”. In some example, the invalid passphrase may be a high-entropy, randomly-generated alphanumeric string that is statistically unlikely to be the correct passphrase for any given private key. If operations can be performed on the key using an invalid passphrase then this indicates that no passphrase has been set on the private key.

At operation 670, the private key algorithm and the key length are added to the metadata package.

The process then loops back to operation 610 to find a next private key for that user account. When all private keys for that account have been found, the process loops back to operation 600 to examine the next user account on the endpoint device. When all accounts have been processed, the private key metadata package is transmitted back to the endpoint management system, at operation 680.

FIG. 7 is a flow diagram of a process for data aggregation and transformation 700, executed by data aggregation and transformation system 260, of FIG. 2, in accordance with an example of the present disclosure.

The process starts at operation 710, by parsing the collected endpoint data (e.g., the public keys, public key metadata, and private key metadata) for each user account on each endpoint device. The data that is collected by, and received from, the endpoint management system may be in a flat file format (e.g., JSON, XML, or YAML), from which the desired information can be parsed. In some examples, the data comprises individual records (e.g., one per machine), which may contain a list of users on the machine, private key metadata discovered on the machine, and public key metadata discovered on the machine. The data, however, does not contain relationship information, which is to say that data collected for Machine A does not contain any reference to users, private keys, or public keys on other machines.

At operation 720, the parsed data is transformed and aggregated into classes that can be associated with properties of nodes of the graph that is to be created. The transformation is performed to format the data in a manner that is compatible with a graph database. For example, each node representing a machine, user account, key pair, network/sub-network, etc., is assigned a unique identifier. It is at this point in the process that records collected from different machines are aggregated. For example, the transformation builds lists of users, machines, private key fingerprints, public key fingerprints, etc. From those lists, items may then be correlated. For example, a record for Machine A may show that a user account authorizes a public key, but that record does not contain any data on that key. However, when examining the record for Machine B, a user account holding the corresponding private key is found. From this, at operation 730, an associated trust relationship can be established between the nodes and converted into a graph representation (e.g., an edge in the graph).

The relationships may be based, for example, on pairings of user accounts with machines, pairings of public key authorizations with user accounts and machines, and any other potential relationships between nodes that may be of interest. The process exploits the fact that the fingerprint values can be used to identify and collate the public and private portions of the key pair. Thus, the actual public and private keys are not required. The graph nodes and relationships (e.g., the graph edges) are then stored in the graph database 265, allowing for queries to subsequently be run in the graph data base query language.

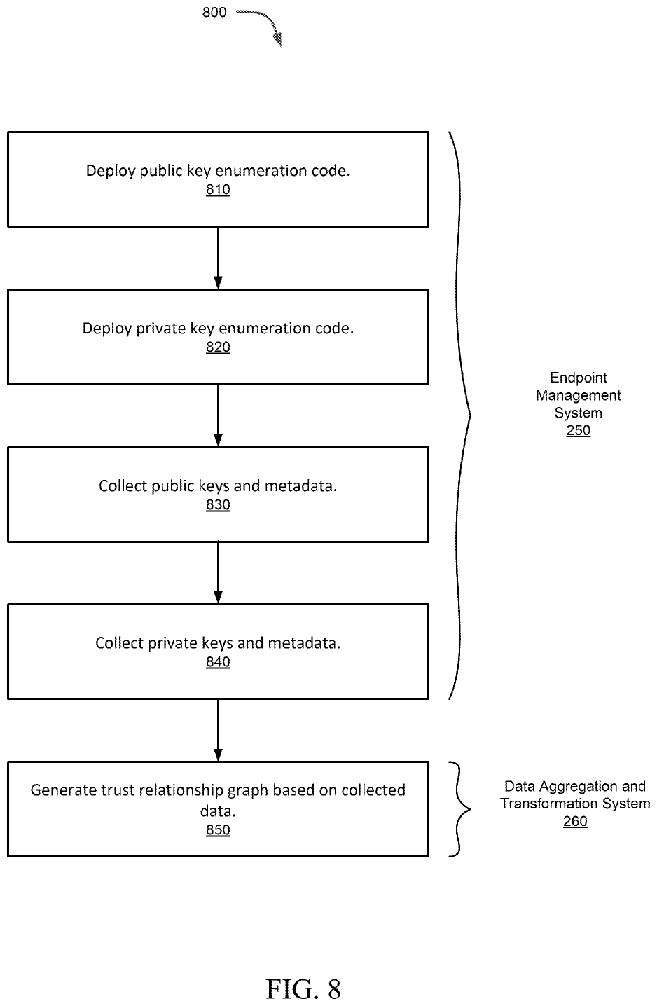

FIG. 8 is a flow diagram of a process for providing graphical visualization of trust relationships, executed by any combination of the system elements/components of trust mapping system 200, of FIG. 2, in accordance with an example of the present disclosure.

The process starts at operation 810, by deploying public key enumeration code to endpoint devices for execution on the endpoint devices. In some examples the public key enumeration code is configured to identify user accounts on the endpoint device, locate public keys associated with each of the user accounts, and calculate a fingerprint of each of the located public keys for inclusion in the associated public key metadata.

Next, at operation 820, private key enumeration code is deployed to the endpoint devices for execution on the endpoint devices. In some examples the private key enumeration code is configured to identify user accounts on the endpoint device, locate private keys associated with each of the user accounts, calculate a fingerprint of each of the located private keys for inclusion in the associated private key metadata, and determine password protection status of the located private keys for inclusion in the associated private key metadata.

At operation 830, public keys and associated public key metadata, as generated by the public key enumeration code, are collected from the endpoint devices. At operation 840, private key metadata, as generated by the private key enumeration code, is collected from the endpoint devices.

At operation 850, a graph is generated, the graph illustrating trust relationships between user accounts on the endpoint devices. The graph is based on the collected public keys, the collected public key metadata, and the collected private key metadata.

In some examples, the graph comprises a plurality of nodes, each of the nodes representing a user account, a machine, a sub-network, or a pairing of public key and private key. In some examples, the graph also comprises a plurality of edges, each of the edges connecting two or more of the nodes. The edges representing an authorization relationship between the connected nodes or a presence relationship between the connected nodes.

In some examples, the nodes and edges are stored in a graph database that is configured to be accessed or queried using a graph query language (e.g., the Cypher query language).

In some examples, a graph is displayed based on a request (e.g., from a security administrator). The request may be entered through a user interface configured to enable entry of requests using the graph query language. The requested graph may comprise a subset of the nodes and edges as specified by the request, for example based on properties of interest associated with the collected metadata.

The processes disclosed herein each depict one particular sequence of acts in a particular example. Some acts are optional and, as such, can be omitted in accord with one or more examples. Additionally, the order of acts can be altered, or other acts can be added, without departing from the scope of the apparatus and methods discussed herein.

### Computing Platform for Graphical Visualization of Trust Relationships

FIG. 9 is a block diagram of a computing platform 900 configured to perform a process for providing graphical visualization of trust relationships for use in detection of network attack paths, in accordance with an example of the present disclosure. In some cases, the platform 900 may be a workstation, server, laptop, mobile device, or smartphone.

The computing platform or device 900 includes one or more processors 910, volatile memory 920 (e.g., random access memory (RAM)), non-volatile memory 930, one or more network or communication interfaces 940, user interface (UI) 280, display element (e.g., screen) 970, and a communications bus 950. The computing platform 900 may also be referred to as a computer or a computer system.

The non-volatile (non-transitory) memory 930 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 280 can include one or more input/output (I/O) devices (e.g., a mouse, a keyboard, a microphone, one or more speakers, one or more biometric scanners, one or more environmental sensors, and one or more accelerometers, etc.).

The display element 970, can provide a graphical user interface (GUI) and in some cases, may be a touchscreen or any other suitable display device.

The non-volatile memory 930 stores an operating system 932, one or more applications 934, data 936, and system elements 250, 260, and 270 of FIG. 2 such that, for example, computer instructions of the operating system 932, the applications 934, and the system elements 250, 260, and 270, are executed by processor(s) 910 out of the volatile memory 920. In some examples, the volatile memory 920 can include one or more types of RAM and/or a cache memory that can offer a faster response time than a main memory. Data can be entered through the user interface 280. Various elements of the computer 900 can communicate via the communications bus 950. In some examples, data 936 may store collected endpoint data DB 240, graph DB 265, and graph query templates 270 of FIG. 2.

The illustrated computing platform 900 is shown merely as an example client device or server and can be implemented by any computing or processing environment with any type of machine or set of machines that can have suitable hardware and/or software capable of operating as described herein.

The processor(s) 910 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor 910 can be analog, digital, or mixed. In some examples, the processor 910 can be one or more physical processors, or one or more virtual (e.g., remotely located or cloud) processors. A processor including multiple processor cores and/or multiple processors can provide functionality for parallel, simultaneous execution of instructions or for parallel, simultaneous execution of one instruction on more than one piece of data.

The network interfaces 940 can include one or more interfaces to enable the computing platform 900 to access a computer network 980 such as a Local Area Network (LAN), a Wide Area Network (WAN), a Personal Area Network (PAN), or the Internet through a variety of wired and/or wireless connections, including cellular connections. In some examples, the network 980 may allow for communication with other computing platforms 990, to enable distributed computing. In some examples, the network 980 may allow for communication with endpoint devices 210.

In described examples, the computing platform 900 can execute an application on behalf of a user of a client device. For example, the computing platform 900 can execute one or more virtual machines managed by a hypervisor. Each virtual machine can provide an execution session within which applications execute on behalf of a user or a client device, such as a hosted desktop session. The computing platform 900 can also execute a terminal services session to provide a hosted desktop environment. The computing platform 900 can provide access to a remote computing environment including one or more applications, one or more desktop applications, and one or more desktop sessions in which one or more applications can execute.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

1. A computer system comprising:
a memory; and
at least one processor coupled to the memory and configured to:
deploy public key enumeration code to a plurality of endpoint devices for execution on the endpoint devices;
deploy private key enumeration code to the plurality of endpoint devices for execution on the endpoint devices;
collect public keys and associated public key metadata from the endpoint devices, the public keys and associated public key metadata generated by the public key enumeration code;
collect private key metadata from the endpoint devices, the private key metadata generated by the private key enumeration code; and
generate a graph illustrating trust relationships between user accounts on the endpoint devices, the graph based on the collected public keys, the collected public key metadata, and the collected private key metadata.

2. The computer system of claim 1, wherein the public key enumeration code is configured to:
identify user accounts on the endpoint device;
locate public keys associated with each of the user accounts; and
calculate a fingerprint of each of the located public keys for inclusion in the associated public key metadata.

3. The computer system of claim 1, wherein the private key enumeration code is configured to:
identify user accounts on the endpoint device;
locate private keys associated with each of the user accounts;
calculate a fingerprint of each of the located private keys for inclusion in the associated private key metadata; and
determine password protection status of the located private keys for inclusion in the associated private key metadata.

4. The computer system of claim 1, wherein the graph comprises a plurality of nodes, each of the nodes representing one of a user account, a machine, a sub-network, or a pairing of public key and private key.

5. The computer system of claim 4, wherein the graph comprises a plurality of edges, each of the edges connecting two or more of the nodes, each of the edges representing one or more of an authorization relationship between the two or more nodes, an ownership relationship between the two or more nodes, or a presence relationship between the two or more nodes.

6. The computer system of claim 5, wherein the at least one processor is further configured to:
store the plurality of nodes and the plurality of edges in a graph database; and
provide access to the graph database using a graph query language.

7. The computer system of claim 6, wherein the at least one processor is further configured to:
provide a user interface to enable entry of a request using the graph query language; and
display a requested graph, the requested graph comprising a subset of the plurality of nodes and a subset of the plurality of edges, the subset of the plurality of nodes and the subset of the plurality of edges specified by the request.

8. A method for graphical visualization of trust relationships comprising:
deploying, by a computer system, public key enumeration code to a plurality of endpoint devices for execution on the endpoint devices;
deploying, by the computer system, private key enumeration code to the plurality of endpoint devices for execution on the endpoint devices;
collecting, by the computer system, public keys and associated public key metadata from the endpoint devices, the public keys and associated public key metadata generated by the public key enumeration code;
collecting, by the computer system, private key metadata from the endpoint devices, the private key metadata generated by the private key enumeration code; and
generating, by the computer system, a graph illustrating trust relationships between user accounts on the endpoint devices, the graph based on the collected public keys, the collected public key metadata, and the collected private key metadata.

9. The method of claim 8, wherein the public key enumeration code is configured to:
identify user accounts on the endpoint device;
locate public keys associated with each of the user accounts; and
calculate a fingerprint of each of the located public keys for inclusion in the associated public key metadata.

10. The method of claim 8, wherein the private key enumeration code is configured to:
identify user accounts on the endpoint device;
locate private keys associated with each of the user accounts;
calculate a fingerprint of each of the located private keys for inclusion in the associated private key metadata; and
determine password protection status of the located private keys for inclusion in the associated private key metadata.

11. The method of claim 8, wherein the graph comprises a plurality of nodes, each of the nodes representing one of a user account, a machine, a sub-network, or a pairing of public key and private key.

12. The method of claim 11, wherein the graph comprises a plurality of edges, each of the edges connecting two or more of the nodes, each of the edges representing one or more of an authorization relationship between the two or more nodes, an ownership relationship between the two or more nodes, or a presence relationship between the two or more nodes.

13. The method of claim 12, further comprising:
storing the plurality of nodes and the plurality of edges in a graph database; and
providing access to the graph database using a graph query language.

14. The method of claim 13, further comprising:
providing a user interface to enable entry of a request using the graph query language; and
displaying a requested graph, the requested graph comprising a subset of the plurality of nodes and a subset of the plurality of edges, the subset of the plurality of nodes and the subset of the plurality of edges specified by the request.

15. A non-transitory computer readable medium storing executable sequences of instructions to provide graphical visualization of trust relationships, the sequences of instructions comprising instructions to:
deploy public key enumeration code to a plurality of endpoint devices for execution on the endpoint devices;
deploy private key enumeration code to the plurality of endpoint devices for execution on the endpoint devices;
collect public keys and associated public key metadata from the endpoint devices, the public keys and associated public key metadata generated by the public key enumeration code;
collect private key metadata from the endpoint devices, the private key metadata generated by the private key enumeration code; and
generate a graph illustrating trust relationships between user accounts on the endpoint devices, the graph based on the collected public keys, the collected public key metadata, and the collected private key metadata.

16. The computer readable medium of claim 15, wherein the public key enumeration code is configured to:
identify user accounts on the endpoint device;
locate public keys associated with each of the user accounts; and
calculate a fingerprint of each of the located public keys for inclusion in the associated public key metadata.

17. The computer readable medium of claim 15, wherein the private key enumeration code is configured to:
identify user accounts on the endpoint device;
locate private keys associated with each of the user accounts;
calculate a fingerprint of each of the located private keys for inclusion in the associated private key metadata; and
determine password protection status of the located private keys for inclusion in the associated private key metadata.

18. The computer readable medium of claim 15, wherein the graph comprises a plurality of nodes, each of the nodes representing one of a user account, a machine, a sub-network, or a pairing of public key and private key.

19. The computer readable medium of claim 18, wherein the graph comprises a plurality of edges, each of the edges connecting two or more of the nodes, each of the edges representing one or more of an authorization relationship between the two or more nodes, an ownership relationship between the two or more nodes, or a presence relationship between the two or more nodes.

20. The computer readable medium of claim 19, wherein the sequences of instructions further include instructions to:
store the plurality of nodes and the plurality of edges in a graph database;
provide access to the graph database using a graph query language;
provide a user interface to enable entry of a request using the graph query language; and
display a requested graph, the requested graph comprising a subset of the plurality of nodes and a subset of the plurality of edges, the subset of the plurality of nodes and the subset of the plurality of edges specified by the request.
